(19) United States
(12) Patent Application Publication
(10) Pub. No.: US 2026/0368526 A1
(43) Pub. Date: Nov. 19, 2026

(54) METHOD FOR TRAINING A MACHINE LEARNING SYSTEM

(71) Applicant: Robert Bosch GmbH, Stuttgart (DE)

(72) Inventors: Jasmin Ebert, Heidelberg (DE); Maksym Yatsura, Dornstetten (DE); Nick Wagner, Kornwestheim (DE); Paul Wimmer, Waldstetten (DE)

(21) Appl. No.: 19/662,028

(22) Filed: Apr. 29, 2026

(30) Foreign Application Priority Data
May 15, 2025 (EP) 25 17 6695.2

(51) Int. Cl. G06N 3/084

(52) U.S. Cl. CPC G06N 3/084

(57) ABSTRACT

A computer-implemented method for training a machine learning system using reference data. The reference data include spatial occupancy data, wherein the spatial occupancy data comprise a set of spatial occupancy units, wherein the machine learning system outputs predictions based on input data, wherein the input data are sensor data, wherein the predictions are projected into a reference space of the spatial occupancy data in order to obtain projected predictions, wherein a mapping of the projected predictions to the spatial occupancy data is carried out, wherein an error of the projected predictions with respect to the spatial occupancy data is calculated by means of an error function, wherein the machine learning system is optimized on the basis of the error. A device and a computer program are also described.

### CROSS REFERENCE

The present application claims the benefit under 35 U.S.C. § 119 of Europe Patent Application No. EP 25 17 6695.2 filed on May 15, 2025, which is expressly incorporated herein by reference in its entirety.

### FIELD

The present disclosure relates to a computer-implemented method for training a machine learning system. Furthermore, the present disclosure relates to a device and to a computer program.

### BACKGROUND INFORMATION

The availability of reference data for training a machine learning system is of decisive importance. Current methods use manually annotated data or data with automatically generated annotations as reference data. Both methods relate to providing sensor data with annotations in order to use these for training. Here, a disadvantage is that manual annotation of data is a cost-intensive and time-consuming process, while automatically generated annotations often have low precision and the generation is likewise cost-intensive and resource-intensive.

Thus, there is a need for a method for training a machine learning system, using reference data, which is both cost-efficient and time-efficient and also provides precise annotations.

### SUMMARY

The method according to the present disclosure for training a machine learning system using reference data has the advantage that the reference data comprise spatial occupancy data, wherein the spatial occupancy data comprise a set of spatial occupancy units, wherein the machine learning system outputs predictions based on input data, wherein the input data are sensor data, wherein the predictions are projected into a reference space of the spatial occupancy data in order to obtain projected predictions, wherein a mapping of the projected predictions to the spatial occupancy data is carried out, wherein an error of the projected predictions with respect to the spatial occupancy data is calculated by means of an error function, wherein the machine learning system is optimized on the basis of the error function.

A machine learning system is understood in particular to be a computer-based system that uses algorithms and models in order to learn from data and based thereon, for example, to make predictions or decisions and in particular to control actuators. The machine learning system can be, for example, an artificial neural network. In a preferred embodiment, the machine learning system is in particular a deep neural network.

Training a machine learning system can, in the context of the method according to the present disclosure, in particular comprise a process of adapting model parameters of a machine learning system in order to improve its ability to make predictions based on input data. The input data can in particular be sensor data. Predictions are understood in particular to be outputs of the machine learning system that are generated on the basis of input data and in particular represent estimates or predictions, for example regarding a state, an event or a variable. During training, a dataset is presented to the machine learning system that in particular consists of input data and corresponding reference data. The machine learning system learns to model the relationship between input data and reference data in that in particular its internal model parameters are adapted on the basis of a calculated error of the predictions with respect to the reference data.

Sensor data can in particular comprise a single measurement from a sensor, but also a series of measurements and/or pairs of measured values, for example a measured value and a time stamp. The sensor data can in particular originate from a physical sensor that directly measures a physical variable. Examples of physical sensors are image sensors, radar sensors, lidar sensors, acceleration sensors and/or other devices that detect real phenomena. Alternatively or additionally, the sensor data can originate from a synthetic sensor. A synthetic sensor refers in particular to a computational process and/or a model that generates data that emulate sensor data, however without direct physical measurement. Examples of synthetic sensors are simulations, generative models and/or data augmentation techniques.

Reference data are understood in particular to be data that serve as target values for training the machine learning system. Reference data are produced, for example, by manual or automated annotation of sensor data. They represent in particular expected outputs of the system for given input data and are in particular used to determine the error of the predictions with respect to the reference data during training and to adapt the model parameters of the machine learning system. The reference data can in particular comprise points, boxes and/or polygons.

According to the present disclosure, in particular alternatively or additionally to already existing reference data, spatial occupancy data are used as reference data.

Spatial occupancy data classify in particular regions in a space based on certain criteria. These criteria can, for example, relate to the presence of objects, the affiliation to semantic classes (for example road, building, vegetation), the delimitation of objects by specifying their position and extent (for example bounding boxes, polygons) or other properties of an environment. The spatial occupancy data in particular classify the entire space, since unoccupied regions are also implicitly classified. The spatial occupancy data can assume various forms, such as, for example, discrete occupancy grids, continuous probability distributions, bounding boxes, polygons or instance segmentations. In particular, each region in the space is classified by at least one spatial occupancy unit, wherein the spatial occupancy unit comprises at least one value of a criterion for this region of the space.

A reference space is in particular a space in which the spatial occupancy data are represented by the spatial occupancy units. In an advantageous embodiment, the reference space comprises in particular a discrete grid structure. The predictions of the machine learning system are in particular projected into the reference space, as a result of which projected predictions arise. On the projected predictions, a mapping of the predictions to the spatial occupancy data in particular takes place. In the mapping of the projected predictions to the spatial occupancy data, in particular each projected prediction can be assigned to at least one spatial occupancy unit. The mapping is carried out by means of a strategy that is in particular dependent on a type of the predictions (for example, points, boxes, polygons), a type of the spatial occupancy data (for example, semantic segmentation, instance segmentation), a type of the reference space (for example, discrete grid structure, continuous probability values) along with further possibly present attributes in the predictions and/or spatial occupancy data (for example, velocities, directions). Examples of strategies for the mapping are in particular assignments of predictions that describe an object in the space to spatial occupancy units that express an occupied space.

Based on the mapping, an error is in particular calculated by means of an error function, which expresses, for example, a deviation of the projected predictions with respect to the spatial occupancy data. Thereupon, the model parameters of the machine learning system are in particular optimized on the basis of the error function in order to minimize the error. Here, typical methods are, for example, backpropagation or gradient descent.

Training a machine learning system using spatial occupancy data as reference data is in particular advantageous if not many other pieces of reference data are present or the training is to be improved by further reference data, in particular if the spatial occupancy data are already available from another process step. It is particularly advantageous that the spatial occupancy data can be integrated directly into an existing training process with the aid of the mapping of the projected predictions to the spatial occupancy data and can be used together with other reference data for training a machine learning system. Thus, in particular, no far-reaching adaptation of the existing training process is necessary.

Advantageous developments and improvements of the method are made possible by the configurations disclosed herein.

In a particularly advantageous example embodiment, the error function is designed to take into account errors of at least two types of reference data for a prediction.

Types of reference data are understood in particular to be reference data from different sources (for example, manually annotated reference data, automatically annotated reference data and/or spatial occupancy data used as reference data), which describe, for example, the same prediction. The error of the prediction is in particular ascertained separately with each type of reference data and subsequently combined in the error function, for example by addition. In an advantageous embodiment, the different types of reference data are weighted by optimizable weights, for example by multiplication. The weights are in particular hyperparameters that can be adapted in an optimization process in order, for example, to take into account different quality levels of reference types; thus, for example, types of reference data of lower quality can be weighted less strongly than types of reference data of higher quality.

Due to a use of different types of reference data, in particular for one prediction, the training of the machine learning system can be improved and types of reference data of different quality can be taken into account. Due to a combination in the error function, the method can be easily integrated into an existing training process and expanded with further types of reference data.

In an advantageous example embodiment, the reference data comprise further attributes, wherein the further attributes comprise static attributes and/or dynamic attributes, wherein the further attributes are used for the mapping of the projected predictions to the spatial occupancy data.

Static attributes are in particular attributes that describe inherent, time-independent properties of objects or regions in the space. Examples of static attributes can include, inter alia, shape, size, color, material properties or a classification of a region.

Using static attributes can improve an accuracy of the mapping of the projected predictions to the spatial occupancy data in that they provide additional information regarding objects and/or regions that is independent of their movement or state.

Dynamic attributes are in particular attributes that describe the state or movement of objects or regions in the space and can change over time. Examples of dynamic attributes can include, inter alia, velocity, direction, acceleration or temporal changes of other properties.

Using dynamic attributes can support a temporal consistency of the mapping and/or a prediction of future states.

Further attributes of the reference data can in particular be assigned to spatial occupancy units, wherein the further attributes can, for example, be matched with attributes of the predictions. Attributes of the predictions that are not present in the reference data are in particular ignored and are not taken into account for the mapping.

In an exemplary embodiment, velocities and directions can in particular be used for object tracking algorithms.

In a particularly advantageous example embodiment, the spatial occupancy data comprise, for each spatial occupancy unit, at least one confidence value that in particular indicates a reliability of the particular spatial occupancy unit, and wherein spatial occupancy units of which the confidence value lies below a predetermined threshold value are ignored for the mapping of the projected predictions with the spatial occupancy data.

A confidence value indicates in particular the reliability of a particular spatial occupancy unit. A high confidence value means that information regarding the occupancy of the corresponding spatial occupancy unit is considered reliable, whereas a low confidence value implies lower reliability. The confidence value can, for example, be an output of a machine learning system that is used for producing the spatial occupancy data and can in particular be based on a quality of sensor data, an uncertainty of measurements and/or a consistency of information from different sensors. In order to minimize the influence of spatial occupancy units with low reliability on the training of the machine learning system, spatial occupancy units of which the confidence value lies below a predetermined threshold value are in particular ignored for the mapping of the projected predictions with the spatial occupancy data. This threshold value can in particular be adapted on the basis of requirements of an application and/or taking into account expert knowledge. Alternatively or additionally, optimization algorithms can be used in order to optimize the threshold value. Due to the use of confidence values and the ignoring of unreliable spatial occupancy units, the robustness and accuracy of the training can be improved.

In an advantageous example embodiment, the error of the projected predictions with the reference data is determined with at least one similarity measure, in particular Intersection over Union or Dice loss.

A similarity measure quantifies in particular an agreement between the projected predictions and the spatial occupancy data. A high value of the similarity measure means, for example, a high agreement, whereas a low value indicates a low agreement. Here, a low agreement corresponds in particular to a higher error. A selection of the similarity measure depends on a type of the predictions and/or of the spatial occupancy data. In particular, methods such as Intersection over Union (IoU), Dice loss or other suitable similarity measures can be used. Intersection over Union determines the ratio of an intersection to a union of the projected predictions and spatial occupancy data assigned to a corresponding projected prediction. Dice loss is defined as one minus the Dice coefficient, which measures a similarity between two sets. Using a similarity measure makes a quantitative evaluation of the error of the predictions possible and serves as a basis for the optimization of the machine learning system.

In an advantageous example embodiment, the reference space of the spatial occupancy data is constructed according to a grid structure, wherein the grid structure comprises grid cells, wherein at least one spatial occupancy unit is assigned to each grid cell, wherein the predictions are projected onto the grid cells.

A grid structure comprises in particular a regular arrangement of grid cells that subdivide the reference space into discrete units. At least one spatial occupancy unit is assigned to each grid cell, which contains information regarding occupancy of the corresponding region in the space. The predictions of the machine learning system are projected onto the grid cells. This in particular makes a direct comparison between the predictions and the spatial occupancy data possible. The grid structure of the reference space in particular simplifies, due to its discrete structure, the mapping between the predictions and the reference data and makes an efficient optimization of the machine learning system possible.

In a particularly advantageous example embodiment, the machine learning system comprises a multitask network, wherein a part of the multitask network determines the spatial occupancy data, wherein at least a second part of the multitask network is trained using the spatial occupancy data.

A multitask network is in particular a neural network that processes a plurality of, in particular different, tasks simultaneously. The multitask network comprises in particular at least two paths, wherein in a first path the spatial occupancy data are determined. This first path of the multitask network in particular receives input data, for example sensor data, and generates as output the spatial occupancy data that represent an environment. At least a second path of the multitask network is trained using the spatial occupancy data generated by the first path. This second part of the network in particular produces the predictions, which comprises, for example, a recognition and classification of objects in an environment, a prediction of movements or a planning of actions. Due to the use of the spatial occupancy data as reference data in the training process, the accuracy and robustness of the at least second path can be improved.

Here, using the spatial occupancy data as reference data is particularly advantageous, since they are generated within the framework of the multitask network in the first path in particular independently of the training of the at least second path. Thus, no additional resources are required for generating the spatial occupancy data. The at least two paths in particular do not have to be executed simultaneously.

In an advantageous example embodiment, the predictions comprise polygons, wherein the mapping of the projected predictions with the spatial occupancy data is carried out in particular on the basis of a recognition of changes in the spatial occupancy data.

The mapping of the projected predictions with the spatial occupancy data is carried out in this embodiment in particular on the basis of a recognition of changes in the spatial occupancy data. This method uses information with respect to transitions between different regions and/or classes in the spatial occupancy data in order to position comparison polygons in the spatial occupancy data and to adapt them along transitions of regions.

Advantageously, the recognition of changes in the spatial occupancy data can be carried out by means of edge detection algorithms. Edge detection algorithms identify transitions along regions in the reference space in which the values of the spatial occupancy data change, for example at boundaries between occupied and free regions and/or between regions of different semantic classes. Recognized edges can then be used for positioning the comparison polygons. The comparison polygons are aligned along the recognized edges. The polygons comprised by the predictions are compared with the comparison polygons according to conventional methods, in order to determine the error of the projected predictions with respect to the spatial occupancy data.

This method offers in particular the advantage that the polygons comprised by the predictions can be compared precisely with the spatial occupancy data, even if the spatial occupancy data are noisy or incomplete. Due to the use of the information regarding changes in the spatial occupancy data, the robustness and accuracy of the mapping of the predictions, for example, are improved.

In a particularly advantageous example embodiment, the machine learning system that has been trained with an embodiment of the method according to the present disclosure is used to control a robot, wherein the sensor data are in particular lidar data, radar data and/or image data.

A robot refers in particular to an autonomous and/or remotely controlled system with sensors and actuators that is used for interaction with its environment. Examples of robots are in particular industrial robots, service robots and autonomous vehicles.

Lidar data are in particular three-dimensional point data that capture the environment by scanning with laser beams. They provide, for example, information regarding distances, positions and/or shapes of objects.

Radar data are in particular data that are obtained by transmitting radio waves and measuring the reflected signals. They provide, for example, information regarding distances, positions and/or shapes of objects.

Image data are in particular two-dimensional data that are captured by image sensors with a matrix of photosensitive pixels and that represent the visual perception of an environment with a certain spatial resolution. Each pixel captures in particular the light intensity in a certain region. The image data provide, for example, information regarding colors, brightness, textures and extent of objects.

Using a machine learning system that has been trained with an embodiment of the method according to the present disclosure is particularly advantageous since, due to the use of the spatial occupancy data as reference data, additional reference data are available that can improve the training of the machine learning system, in particular for regions with not many pieces of reference data.

In a particularly advantageous example embodiment, the robot is in particular an autonomous vehicle, wherein, based on outputs of the machine learning system, a longitudinal movement and/or transverse movement of the autonomous vehicle is controlled, in particular a distance control, lane control and/or automatic emergency braking.

Autonomous vehicles are in particular land, air and/or water vehicles that can move independently in their environment. Autonomous vehicles use sensor data in particular for detecting objects, lane markings and other environmental information.

Based on generated predictions of the machine learning system, which describe, for example, positions and classes of objects, road boundaries or movements of objects, decisions regarding the longitudinal movement and/or transverse movement of the autonomous vehicle are made. This comprises in particular functions such as a distance control that regulates a distance to a preceding vehicle, a lane control that keeps the autonomous vehicle within a lane, and/or an automatic emergency braking that automatically initiates emergency braking in the event of an impending collision.

In particular for training machine learning systems for autonomous vehicles, a large number of reference data is important, since the machine learning system must correctly detect and evaluate complex environments in different situations, wherein, due to the use of the spatial occupancy data as reference data, additional reference data are available.

An exemplary example embodiment of the present disclosure is explained in more detail below based on the FIGURE.

### BRIEF DESCRIPTION OF THE DRAWING

FIG. 1 is a schematic representation of an example embodiment of a training of a machine learning system.

### DETAILED DESCRIPTION OF EXAMPLE EMBODIMENTS

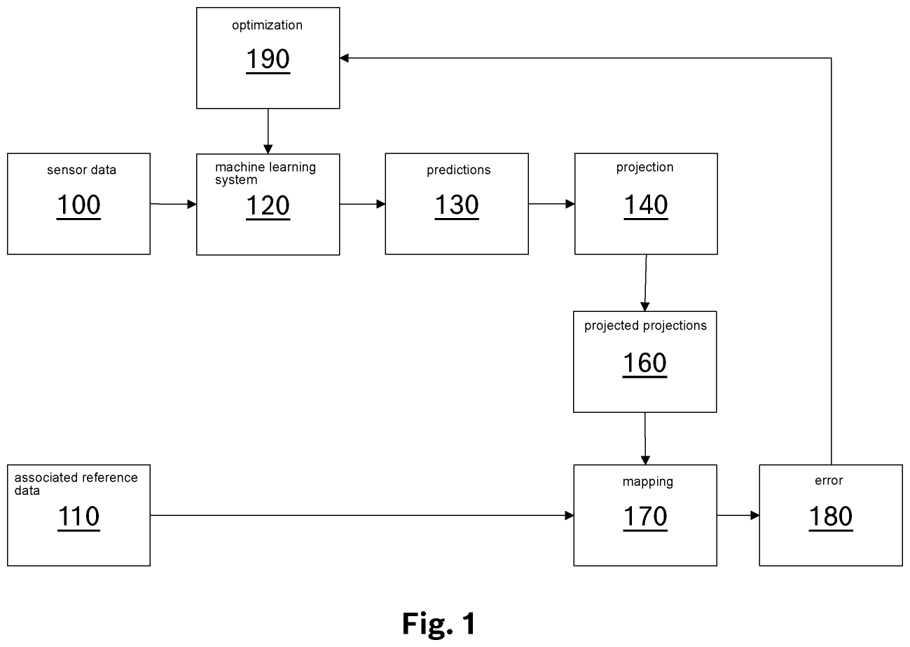

FIG. 1 is, by way of example, a schematic representation of an embodiment of a training of a machine learning system using reference data.

Initially, sensor data (100) are provided as input data of a machine learning system (120), wherein the sensor data are in particular lidar data, radar data and/or image data.

Subsequently, the machine learning system (120) makes predictions (130) (for example, objects and/or markings) based on the sensor data (100).

The predictions (130) are then projected by means of a projection (140) into a reference space of associated reference data (110) in order to obtain projected predictions (160), wherein the reference data comprise target values of the predictions (130) for the sensor data (100). The reference data (110) are in particular spatial occupancy data that describe in particular a space detected by the sensor data. The projection (140) can in particular comprise a transformation of coordinate systems along with scalings.

Subsequently, a mapping (170) of the projected predictions (160) to the reference data (110) is carried out, wherein, for example, objects of the projected predictions (160) are assigned to instance segmentations and/or semantic segmentations of the reference data (110).

Based on the mapping (170), an error (180) of the projected predictions (160) with respect to the reference data (110) is determined by means of an error function. Different types of reference data in particular can be combined in the error function. An example of an error function is described in formula (1).

$${F}_{total} = {\sum }_{i = 1}^{n} {α}_{i} {F}_{i} \qquad ( 1 )$$

Here, Fₜₒₜₐₗ is the error (180) which results from the sum over n partial errors Fᵢ, weighted by hyperparameters αᵢ. Where n is in particular a number of different types of reference data and Fᵢ is a particular partial error of a corresponding type of reference data. The partial errors can be calculated depending on the type of reference data, for example by Intersection over Union, Dice loss or other methods.

Based on the error (180), an optimization (190) of the machine learning system (120) is carried out in order to minimize the error (180). The training of the machine learning system can be iteratively repeated according to the described method until the error (180) lies below a predetermined threshold value.

What is claimed is:

1. A computer-implemented method for training a machine learning system, using reference data, the reference data including spatial occupancy data, wherein the spatial occupancy data include a set of spatial occupancy units, the method comprising the following steps:
outputting, by the machine learning system, predictions based on input data, wherein the input data are sensor data;
projecting the predictions into a reference space of the spatial occupancy data to obtain projected predictions;
carrying out a mapping of the projected predictions to the spatial occupancy data;
calculating an error of the projected predictions with respect to the spatial occupancy data using an error function; and
optimizing the machine learning system based on the error.

2. The method according to claim 1, wherein the error function is configured to take into account errors of at least two types of reference data for each of the predicted predictions.

3. The method according to claim 1, wherein the reference data include further attributes, wherein the further attributes include static attributes and/or dynamic attributes, wherein the further attributes are used for the mapping of the projected predictions to the spatial occupancy data.

4. The method according to claim 1, wherein the spatial occupancy data include, for each spatial occupancy unit of the spatial occupancy units, at least one confidence value that indicates a respective reliability of the spatial occupancy unit, and wherein spatial occupancy units for which the respective confidence value lies below a predetermined threshold value are ignored for the mapping of the projected predictions to the spatial occupancy data.

5. The method according to claim 1, wherein the error of the projected predictions with respect to the spatial occupancy data is determined with at least one similarity measure including Intersection over Union or Dice loss.

6. The method according to claim 1, wherein the reference space of the spatial occupancy data is constructed according to a grid structure, wherein the grid structure includes grid cells, wherein at least one spatial occupancy unit of the spatial occupancy units is assigned to each grid cell, wherein the predictions are projected onto the grid cells.

7. The method according to claim 1, wherein the machine learning system includes a multitask network, wherein a part of the multitask network determines the spatial occupancy data, wherein at least a second part of the multitask network is trained using the spatial occupancy data.

8. The method according to claim 1, wherein the projected predictions include polygons, wherein the mapping of the projected predictions to the spatial occupancy data is carried out based on a recognition of changes in the spatial occupancy data.

9. The method according to claim 1, wherein the trained machine learning system controls a robot, and wherein the sensor data are at least one of lidar data, radar data, or image data.

10. The method according to claim 9, wherein the robot is an autonomous vehicle, and wherein, based on outputs of the machine learning system, a longitudinal movement and/or transverse movement of the autonomous vehicle is controlled, including at least one of a distance control, lane control, or automatic emergency braking.

11. A device configured to train a machine learning system, using reference data, the reference data including spatial occupancy data, wherein the spatial occupancy data include a set of spatial occupancy units, the device configured to perform the following steps:
outputting, by the machine learning system, predictions based on input data, wherein the input data are sensor data;
projecting the predictions into a reference space of the spatial occupancy data to obtain projected predictions;
carrying out a mapping of the projected predictions to the spatial occupancy data;
calculating an error of the projected predictions with respect to the spatial occupancy data using an error function; and
optimizing the machine learning system based on the error.

12. A non-transitory machine-readable storage medium on which is stored a computer program training a machine learning system, using reference data, the reference data including spatial occupancy data, wherein the spatial occupancy data include a set of spatial occupancy units, the computer program, when executed by a computer, causing the computer to perform the following steps:
outputting, by the machine learning system, predictions based on input data, wherein the input data are sensor data;
projecting the predictions into a reference space of the spatial occupancy data to obtain projected predictions;
carrying out a mapping of the projected predictions to the spatial occupancy data;
calculating an error of the projected predictions with respect to the spatial occupancy data using an error function; and
optimizing the machine learning system based on the error.
